(19) United States
(12) Patent Application Publication
(10) Pub. No.: US 2008/0049553 A1
(43) Pub. Date: Feb. 28, 2008

(54) Method and apparatus for seismic data interpretation using 3D overall view

(76) Inventors: Anil Chopra, Plano, TX (US); Dennis Ross Yarwood, Flower Mound, TX (US); Bijoy Chattopadhyay, Plano, TX (US); Rajesh Kumar Bhairampally, Plano, TX (US); Steven Jerome Malecek, Plano, TX (US)

Correspondence Address: BIJOY CHATTOPADHYAY, Suite 201, 5240 Tennyson Parkway, Plano, TX, 75024, US

(21) Appl. No.: 11/510,814

(22) Filed: Aug. 28, 2006

(51) Int. Cl. G01V 1/34

(52) U.S. Cl. 367/68

(57) ABSTRACT

In accordance with the present invention, a method that utilizes 3D overall view (O-view) for interactively interpreting geophysical and geological data to produce instantaneously sub-surface geologic maps, geologic features, cross-sections and models, are disclosed.

The system provides the user a new capability of interactively interpret seismic data for immediate response. The system allows users to make any corrections interactively on instantaneous basis that is necessary as the interpretation progresses.

The main focus of the invention is to provide an overall 3D view of seismic data so that users can interactively work with the 3D volume and gain knowledge for interpretation with real time response.

One of the main uses of seismic data is to explore oil and gas availability in a prospective oil and gas field. Such exploration process consists of studying seismic patterns of the prospective fields and determines if they have potential for yielding oil and gas. This requires accurate visualization and interaction of the seismic data patterns, and interaction with the seismic data and well log information.

Although the existing tools to visualize seismic data helped to automate certain seismic data interpretation aspects, these tools are confined to presenting the data on the computer screen in a 2D plane for interaction. As such, the flexibility of studying the seismic patterns from an inclined point of view and interact with the seismic data on the computer display, that could have been easily done in 3D view, are now missing. While some attempts are made by using 3D seismic display, the actual data interpretation is still in 2D plane.

The seismic interpretation system that is claimed in this disclosure uses a computer including a portable computer system, known as “Tablet PC” to interpret seismic data that is collected in an industry standard, known as the SEGY format. SEGY is the standard seismic data exchange format and is administered by the SEG (Society of Exploration Geophysicists) Technical Standards Committee. The innovation that is disclosed here fills gaps in the interpretation system that are explained above. The disclosed system permits the users to view and interpret data in an inclined view and also allows users to interact with the displayed data with the help of input devices such as mouse, stylus or electromagnetic pen, or similar other input device.

The system described in this disclosure consists of several subsystems including volume slicing module, grid skipping module, opacity module, control module, and dual screen module.

The main purpose of volume slicing module is to slice a small portion of volume from the entire volume by preserving the grid size for speedy retrieval of information, whereas grid skipping module segments a comparatively bigger volume by skipping lines at a regular interval that also allows a quick information retrieval with comparatively larger size. The opacity module allows to visualize the volume with different opacity levels such that seismic interpretation and data on the existing line, behind the line and the near by lines can be viewed. The control module controls the visualization by switching ON-OFF of seismic data, interpreted data, and opacity levels. The dual screen module allows the visualizing on 3D view in one computer screen and allows to concurrently interpreting either in a 3D plane or in 2D plane in another screen.

### DETAILED DESCRIPTION OF THE PREFERRED EMBODIMENTS OF THE INVENTION

The system 5 in FIG. 1 is an embodiment of a computer system 10 including tablet PC consists of one or more input devices 11 such as keypad, touch screen, mouse, microphone, or other suitable pointer or device that accepts information. An output device 12 such as monitor or other display devices conveys information associated with the operation of computer system 10. The computer system 10 may also include fixed or movable storage media such as magnetic computer disk, CD-ROM, or other suitable media to either receive output from, or provide input to, the computer system 10. This type of system has an additional input device along with those for the system shown in FIG. 1, and is known as “stylus” or “digital pen” or “electromagnetic pen” or simply “pen”.

Referring to FIG. 2, one embodiment of computer system 20 that includes memory 24, one or more processor(s) 22, one or more hard drive(s) 23, standard input device interfaces 21 including, but not limited to, Electro-Magnetic field related input interfaces 26, PS2 ports, USB ports, Serial and parallel ports, wireless and infrared ports, standard output interface ports 25 including, but not limited to, those for speakers and other audio devices, display monitor or other display devices and other similar video devices.

FIG. 3 shows an embodiment of software configuration that is required to run seismic interpretation system software 33, which includes the operating system 31 that provides a graphical user interface system 32, seismic interpretation software 33 and a database 34.

FIG. 4 shows one embodiment of seismic interpretation system software 40 that includes a collection of modules consisting of, but not limited to, volume slicing module 41, grid skipping module 42, opacity module 43, control module 44, dual screen module 45.

The volume slicing module 41 allows a small segment of volume to be cut out from the entire volume. The small segment preserves the original grid size and this small segment of interest can be utilized for interpretation and other purposes.

The grid skipping module 42 allows to cut out a bigger segment but skipping the lines. This allows visualizing and interacting with a bigger volume size, and helps to comprehend the seismic interpretation.

The opacity module 43 allows changing the opacity of interpreted data. This allows viewing existing lines, as well as data behind and nearby lines.

The control module 44 works in conjunction with module 42 and 43. It controls the lines to skip and opacity level.

The dual screen module 45 allows displaying 3D in one screen and 2D or 3D in another screen. This allows interpreting concurrently in 2D or in 3D plane and visualizing in 3D plane.

### TECHNICAL FIELD OF THE INVENTION

This invention relates in general to the field of Geophysics, and more particularly in seismic data interpretation field.

### PRIOR ART DETAILS

In accordance with the present invention, no prior art exists in seismic data interpretation that uses 3D overall view interactively for seismic data interpretation, and for creating geologic features immediately. The existing tools developed today use high degree of repetitive mouse clicks to pick seismic horizon and faults for visualization and analysis.

### Current State of the Art

The capability of current tools involving 3D static or perspective view lacks the interactivity of interpretation and does not provide the ability to interpret in various seismic planes concurrently. This prevents users to correct the interpretation quickly and thus causes loss of time in interpretation, and subsequently the interpretation may be susceptible to errors.

### Assignee

Plano Research Corporation

5240 Tennyson Parkway, Suite 201

Plano, Tex. 75024

### Authors, Assignors and Patenters

Dr. Anil Chopra

Mr. Dennis Ross Yarwood

Dr. Bijoy Chattopadhyay

Mr. Rajesh Bhairmpally

Mr. Steve J. Malecek

### BRIEF DESCRIPTION OF THE DRAWINGS

The details of a preferred embodiment of the present invention, both as to its structure and operation, can best be understood in reference to the accompanying drawings, in which like reference materials refer to like parts, and in which:

FIG. 1 is an embodiment of a computer system for interpreting seismic data associated with seismic file.

FIG. 2 shows a minimum computer hardware system configuration that is used in FIG. 1.

FIG. 3 is an embodiment of software system that contains one or more operating systems and one or more types of databases along with seismic interpretation system.

FIG. 4 is an embodiment of the software modules that are required for seismic data interpretation system referred in FIG. 5.

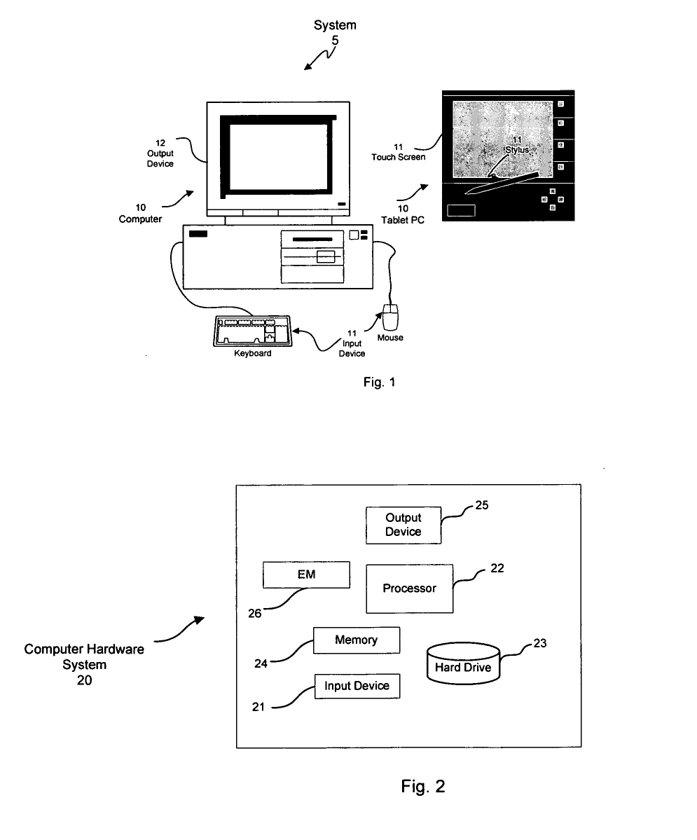

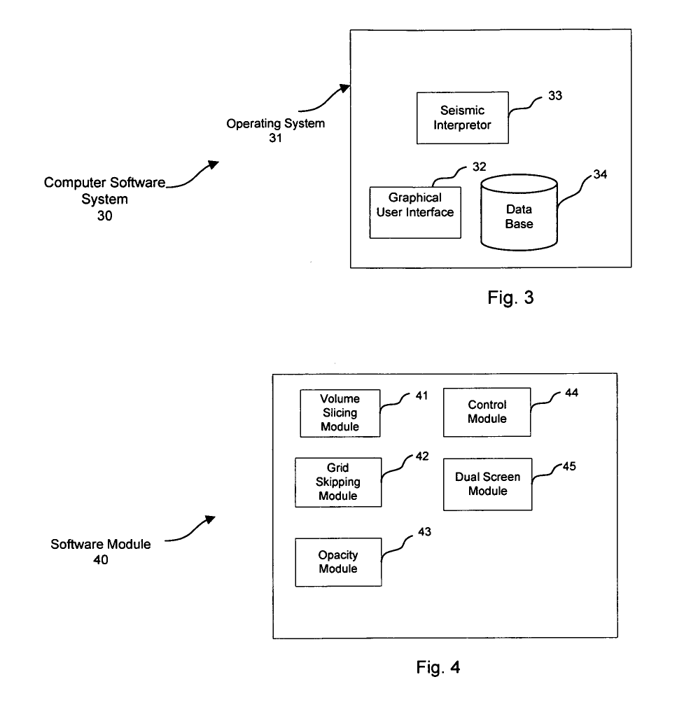

What is claimed is:

1. A system for real time interpretation of seismic data, said system and method comprising:
a computer with display device;
a computer with display on a touch sensitive screen operable to interpret seismic data associated with SEGY data files;
a computer with a screen that is capable of accepting inputs from electro-magnetic field enabled input devices;
a digital pen stylus operable to interpret data associated with seismic data file;
a stylus operable to interpret data associated with seismic data file;
a database operable to collect interpreted data;
a digital pen with electromagnetic field operable to interpret data associated with seismic data file;
a pointing device at least including computer mouse operable to interpret data associated with seismic data file;

2. The system of claim 1, wherein said computer includes a module when executed by said computer selects a small volume of seismic data from the whole volume that is favorable to faster retrieval from the disk.

3. The system of claim 1, wherein said computer includes a module when executed by said computer selects a volume with increments of seismic line from the whole volume that is favorable to faster retrieval from the disk.

4. The system of claim 1, wherein said computer includes a module operable when executed by said computer to display volume with different opacity level for the data in order to visualize seismic interpretation and data on the existing line, behind the line and lines near by.

5. The system of claim 1, wherein said computer includes a module that will turn ON and OFF the opacity level for visualization.

6. The system of claim 1, wherein said computer includes a module that allows to visualize only seismic data, only interpretation, and/or seismic data with interpretation.

7. The system of claim 1, wherein said computer includes a module operable when executed by said computer to display 3D volume in a computer monitor and ability click and interprets in 3D and 2D surface concurrently in the same or different computer monitor.
